(19) United States
(12) Patent Application Publication
(10) Pub. No.: US 2025/0200627 A1
(43) Pub. Date: Jun. 19, 2025

(54) SELF-IMPROVING INTERACTIONS WITH AN ARTIFICIAL INTELLIGENCE VIRTUAL ASSISTANT

(71) Applicant: Loop Now Technologies, Inc., San Mateo, CA (US)

(72) Inventors: Edwin Chiu, Cupertino, CA (US); Shi Feng, East Palo Alto, CA (US); Jerry Ting Kwan Luk, Menlo Park, CA (US); Jeremiah Kevin Tu, Sunnyvale, CA (US); Lloyd Stephen van den Berg, Vancouver (CA); Qingwen Wang, Newark, CA (US); Ziming Zhuang, Palo Alto, CA (US)

(73) Assignee: Loop Now Technologies, Inc., San Mateo, CA (US)

(21) Appl. No.: 19/062,138

(22) Filed: Feb. 25, 2025

Related U.S. Application Data
(63) Continuation-in-part of application No. 18/989,061, filed on Dec. 20, 2024.
Application No. 18/989,061 is a continuation-in-part of application No. 18/820,456, filed on Aug. 30, 2024.
Application No. 18/820,456 is a continuation-in-part of application No. 18/585,212, filed on Feb. 23, 2024.
(60) Provisional application No. 63/649,966, filed on May 21, 2024.
(60) Provisional application No. 63/638,476, filed on Apr. 25, 2024.
(60) Provisional application No. 63/571,732, filed on Mar. 29, 2024.
(60) Provisional application No. 63/557,622, filed on Feb. 26, 2024.
(60) Provisional application No. 63/557,623, filed on Feb. 26, 2024.
(60) Provisional application No. 63/557,628, filed on Feb. 26, 2024.
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.

(51) Int. Cl. G06Q 30/0601; G06F 40/40; G06T 11/00

(52) U.S. Cl. CPC G06Q 30/0627; G06F 40/40; G06Q 30/0609; G06T 11/00

(57) ABSTRACT

Techniques for managing artificial intelligence interactions are disclosed. A large language model (LLM) is trained, including information related to products for sale. The product information resides in a product knowledge base. Users interacting with a synthetic human generate input related to the products for sale through an embedded interface included in a website or application. The user input is captured and the LLM creates responses based on information in the product knowledge base. The responses are used to produce video segments that are presented to the user. The user creates additional input based on the video responses from the LLM. The additional input is evaluated and used to trigger self-improving steps to improve the content of the product knowledge base and the responses generated for the user. The self improving includes quality metrics; self-learning instructions; information gap identification; and information collection from third-party websites, product experts, and sellers.

### RELATED APPLICATIONS

This application claims the benefit of U.S. provisional patent applications “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

This application is a continuation-in-part of U.S. patent application “Artificial Intelligence Virtual Assistant Using Large Language Model Processing” Ser. No. 18/989,061, filed Dec. 20, 2024, which claims the benefit of U.S. provisional patent applications “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

The U.S. patent application “Artificial Intelligence Virtual Assistant Using Large Language Model Processing” Ser. No. 18/989,061, filed Dec. 20, 2024 is also a continuation-in-part of U.S. patent application “Livestream With Large Language Model Assist” Ser. No. 18/820,456, filed Aug. 30, 2024, which claims the benefit of U.S. provisional patent applications “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

The U.S. patent application “Livestream With Large Language Model Assist” Ser. No. 18/820,456, filed Aug. 30, 2024 is also a continuation-in-part of U.S. patent application “Synthesized Realistic Metahuman Short-Form Video” Ser. No. 18/585,212, filed Feb. 23, 2024, which claims the benefit of U.S. provisional patent applications “Synthesized Realistic Metahuman Short-Form Video” Ser. No. 63/447,925, filed Feb. 24, 2023, “Dynamic Synthetic Video Chat Agent Replacement” Ser. No. 63/447,918, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, and “Artificial Intelligence Virtual Assistant Using Large Language Model Processing” Ser. No. 63/613,312, filed Dec. 21, 2023.

Each of the foregoing applications is hereby incorporated by reference in its entirety.

### FIELD OF ART

This application relates generally to evaluation and more particularly to self-improving interactions with an artificial intelligence virtual assistant.

### BACKGROUND

Buying and selling products has long been an integral part of human societies across the globe. In civilizations worldwide, traders barter goods and services with one another even today. From ancient times, trade routes over land and sea allowed caravans and shipping fleets to carry products to nations and peoples all over the world. Much of the modern sales industry that exists today began in the United States. Several elements were key in the development of modern sales management—a stable currency, the rule of law, the protection of private property, and the availability of credit. Eventually, all of these components became aspects of the American economic system. Modern salesmanship in the U.S. was also related to the scale of American firms that were founded in the late nineteenth and early twentieth centuries. Large manufacturing corporations hired salespeople in the hundreds and even thousands to create demand for their products, including cars, steel, rail transportation, oil, and shipping.

Many cultural characteristics contributed to the growth of salesmanship in America as well. Routine democratic elections, the lack of an established state church, and the absence of hereditary aristocracy allowed greater social and economic mobility across the population. Political and religious groups were able to compete with rivals for followers without fear of government reprisals or censure. With more fluid class boundaries than in European countries, the skills of salesmanship offered a pathway to personal success. By the early twentieth century, Americans read “how-to-sell” books in large enough numbers to turn several of them into bestsellers.

In the 1900s, sales methodology took many twists and turns particularly in the quest to maximize sales and profits. Psychological selling is focused on understanding the emotions, motivations, and behaviors that drive people to make purchasing choices. Relationship selling developed with an aim toward building connections with customers and potential buyers to close sales. Barrier selling used a series of leading questions asked by the salesperson that could only be answered with “yes.” This technique was used to guide customers into agreeing with the sales representative and making a purchase. Later came the rise of consultative selling, which focused on understanding the customers' needs and providing solutions to their problems. Then in the 1980s, solution selling emerged, which emphasized the importance of selling a complete solution to the customer's problem rather than just a product. Today, sales methodologies continue to evolve, with an increasing emphasis on data-driven sales.

Selling products and services has evolved since its beginnings and will continue to do so. From the early days of traveling vendors and merchants to today's modern salesforces, the selling of products has been an essential part of the American economy and culture. Sales skills offer a path of personal success, and books, videos, and seminars on salesmanship skills continue to sell. The changes in salesmanship techniques and approaches have evolved as the culture, economy, and technology embedded in the country have changed. In the future, salesmanship will continue to adjust as our culture is influenced by changes brought to us from all over the world.

### SUMMARY

Successful sales and customer service interactions require accurate product knowledge and strong communication skills. Whether in person or through digital methods, the representative of the company must know the product and be able to communicate effectively with the customer. The information delivered must be accurate, timely, and as complete as possible. When a customer question that cannot be immediately answered arises, the sales representative must make a determined effort to locate the right information and deliver it promptly. The ability to locate and communicate the right information about products and services can mean the difference between increased or lost sales. Repeat sales can often depend upon great customer service, including the ability to find the information the customer needs and deliver it in a friendly and engaging way. The more quickly and reliably the correct information can be accessed and delivered, the better. As the global market expands potential sales many times, strong sales and support outlets must grow to meet the need.

Techniques for managing artificial intelligence interactions are disclosed. A large language model (LLM) is trained, including information related to products for sale. The product information resides in a product knowledge base. Users interacting with a synthetic human generate input related to the products for sale through an embedded interface included in a website or application. The user input is captured and the LLM creates responses based on information in the product knowledge base. The responses are used to produce video segments that are presented to the user. The user creates additional input based on the video responses from the LLM. The additional input can be evaluated and used to trigger self-improving steps to improve the content of the product knowledge base and the responses generated for the user. The self-improving can include quality metrics; self-learning instructions; information gap identification; and information collection from third-party websites, product experts, and sellers.

A computer-implemented method for evaluation is disclosed comprising: training a large language model (LLM), wherein the training includes a product information, wherein the product information resides within a product knowledge base, and wherein the product information relates to one or more products for sale; collecting, by an embedded interface, input from one or more users, wherein the input from one or more users is related to the one or more products for sale, wherein the embedded interface includes a synthetic human, and wherein the input from one or more users includes a first input from a first user; creating, by the LLM, a response to the first input from a first user, wherein the response is based on the product information within the product knowledge base, wherein the response is responsive to the first input from a first user; producing a video segment, wherein the video segment includes a performance by a synthetic human, wherein the performance is based on the response that was created; presenting, to the first user, within the embedded interface, the video segment that was produced; capturing a second input, from the first user, wherein the second input is responsive to the presenting; evaluating, by the LLM, the response that was created, wherein the evaluating is based on the second input; and self-improving, by the LLM, the product knowledge base, wherein the self-improving is based on the evaluating, and wherein the self-improving relates to the product information. In embodiments, the self-improving comprises determining a quality metric, wherein the determining is based on the second input. Some embodiments comprise revising the product information, wherein the revising is based on the quality metric. In embodiments, the quality metric is based on a relevance of the response. In embodiments, the quality metric is based on an accuracy of the response.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for self-improving interactions with an artificial intelligence virtual assistant.

FIG. 2 is a flow diagram for self-training an artificial intelligence virtual assistant.

FIG. 3 is an infographic for self-improving interactions with an artificial intelligence virtual assistant.

FIG. 4 is an example of an interaction with an artificial intelligence virtual assistant.

FIG. 5 is an infographic for revising a product knowledge base based on a pattern of information gaps.

FIG. 6 is an infographic for autonomously crawling third-party websites.

FIG. 7 is an infographic for updating a product knowledge base by a seller with a client management system.

FIG. 8 is an example of a client management system.

FIG. 9 is a system diagram for self-improving interactions with an artificial intelligence virtual assistant.

### DETAILED DESCRIPTION

Online websites and applications that highlight products and services for sale are immensely popular and can engage hundreds if not thousands of users. The challenge of responding to user questions and comments quickly and accurately can be as difficult as maintaining the technical aspects of providing solid network connections to customers and staff members. Accessing the right information quickly and delivering it to the user who is looking for it can be the difference between a sale or a potential customer leaving the website. Large language models (LLMs) including natural language processing (NLP) can help by monitoring the user interactions and generating answers to questions as they arise. However, not all of the required information for every product offered for sale may be available. New products are added, old products can be updated or sold out, prices can go up or down, discounts change, and so on. Identifying missing pieces of information and filling in the gaps is an ongoing and necessary challenge for any business, whether in the physical or digital world. Finding the right information, and the best way of acquiring the right information, can be key to continued success in the digital marketplace.

Techniques for evaluation are disclosed. A large language model (LLM) can be trained, including product information that resides within a product knowledge base. The product information can be related to products for sale on a website or application. An embedded interface included in the website or application can be used to collect input from one or more users interacting with a synthetic human. The synthetic human can be used to perform responses generated by the LLM regarding products for sale on the website. As the user generates audio, visual, and/or text messages related to products and services on the website, the embedded interface can collect the user input and forward it to the LLM. The LLM can create responses to the user based on the input and the information available in the product knowledge base. The LLM response can be used to generate audio and video featuring the synthetic human performing the LLM response to the user question or comment. As the user continues to interact with the synthetic human, the embedded interface can collect the second, third, fourth, and so on comments and questions from the user and evaluate the LLM responses performed for the user. In some embodiments, the interaction between the user and the synthetic human can continue until the user purchases the product or moves on to a different product on the website. In some embodiments, the evaluation process can reveal a pattern of user inputs that indicates missing information from the product knowledge base. In embodiments, information that is erroneous or missing can be identified by a statistical analysis of the interactions between users and synthetic hosts regarding products in the knowledge base. In some embodiments, missing information can be identified as part of the LLM training process as data elements for one product are compared to data elements of a related product. In some embodiments, a quality metric can be generated to identify data that is missing or inaccurate. Regardless of the method used to identify missing or erroneous data, once a product record is marked for improvement, a self-improving process can be used to gather additional information about the product. The product requiring updating can be flagged in a client management system (CMS), allowing sales or support staff to manually update or correct the product knowledge base. The self-improving process can also use autonomous web crawling to search third-party websites for product information, then add it to the knowledge base. The machine learning model driving the self-improving process can learn from the product knowledge base improvement process itself, so that acquiring and adding updated information about products becomes more efficient. The result is a constantly improving product knowledge base with more complete and accurate information available to be used in synthetic human responses to users. This increases the likelihood of completed sales and higher customer satisfaction.

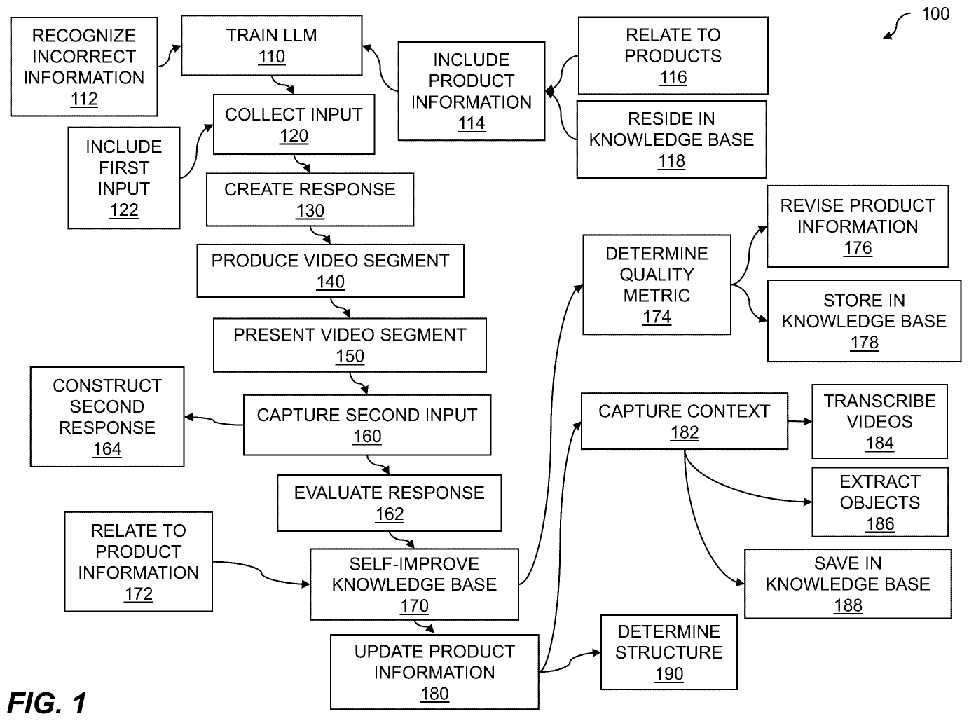

FIG. 1 is a flow diagram for self-improving interactions with an artificial intelligence virtual assistant. The flow 100 includes training a large language model (LLM) 110, wherein the training includes a product information 114, wherein the product information resides within a product knowledge base 118, and wherein the product information relates to one or more products for sale 116. A large language model (LLM) can be a type of machine learning model that can perform a variety of natural language tasks, including generating and classifying text, answering questions in a human conversational manner, and translating text from one language to another. In embodiments, the LLM can be trained with voice and text interactions between users, human sales associates, help desk staff members, product experts, and AI virtual assistants. Information articles and questions covering products and services offered for sale by the website can be included in the LLM knowledge base. A knowledge base can be a centralized collection of information about a specific topic or entity. In embodiments, the knowledge base contains information related to products and services offered by a website or sales application. The knowledge base can hold any type of information related to the products and services offered by the website. The data can be structured text, unstructured text, documents, videos, service or user manuals, sales flyers, brochures, short-form videos, video clips from websites, and so on. The information on products in the knowledge base can be analyzed by the LLM and used to generate answers to questions and comments related to products and services offered for sale.

In embodiments, the training comprises recognizing incorrect information 112 within the product knowledge base. As user questions are received by the LLM and responses are generated based on information in the product knowledge base, the quality of the responses can be measured and used to determine whether additional product information can be added (details on the quality metric are included below). For example, a pair of shoes with a high product information quality metric rating might include information on pricing, descriptions, sizes, widths, colors, store and warehouse quantities, package weights, shipping details, discounts available, return criteria, and so on. Another pair of shoes in the product knowledge base can be missing important information such as sizes or pricing details. In embodiments, the LLM training process can recognize products with an information quality metric below a threshold, due to missing or incorrect information 112 stored in the knowledge base, and can initiate the self-improvement process 170 in order to update and/or correct the product information.

The flow 100 includes collecting 120, by an embedded interface, input from one or more users, wherein the input from one or more users is related to the one or more products for sale, wherein the embedded interface includes a synthetic human, and wherein the input from one or more users includes a first input 122 from a first user. In embodiments, the embedded interface comprises an app running on a mobile device such as a smartphone, tablet, and so on. In embodiments, the embedded interface can comprise a website. The website can be an ecommerce site for a single vendor or brand, a group of businesses, a social media platform, and so on. The website can be displayed on a computing device or a portable device. The portable device can be an Over-the-Top (OTT) device such as a mobile phone, laptop computer, tablet, or pad. The accessing of the website can be accomplished using a browser running on a device. In embodiments, the embedded interface can comprise an app running on a mobile device. The app can use HTTP, TCP/IP, or DNS to communicate with the Internet, web servers, cloud-based platforms, and so on.

In embodiments, an image of a live human can be captured from media sources including one or more photographs, videos, livestream events, and livestream replays, including the voice of the livestream host. A human can be recorded with one or more cameras, including videos and still images, and microphones for voice recording. The recordings can include one or more angles of the human and can be combined to comprise a dynamic 360-degree photorealistic representation of the human. The voice of a human can be recorded and included in a synthetic human. The images of the live human can be isolated and combined in an AI machine learning model into a 3D model that can be used to generate one or more video segments in which the synthetic human performs questions, comments, and answers generated by the large language model (LLM).

In embodiments, the user can request an interaction with the synthetic human by clicking on an icon or button displayed in the embedded interface, clicking on a help button on a webpage, asking for help in a text chat box, navigating to a help desk screen, pressing a phone button during a call, submitting an email to a help desk address, and so on. The user can initiate an interaction from the main webpage of a website, a help menu page, a webpage presenting a specific product, a text or video chatbot embedded in the website, and so on. In embodiments, the audio input generated by the user interacting with the synthetic human can be converted into text. The conversion can be accomplished using an online conversion application, AI transcription service, automatic speech recognition (ASR) application, and so on. The text of the first user input can become a first input 122 that is sent to the LLM for analysis.

The flow 100 includes creating 130, by the LLM, a response to the first input from a first user, wherein the response is based on the product information within the product knowledge base, wherein the response is responsive to the first input from a first user. As mentioned above and throughout, the LLM used to process the first user input can be trained with voice and text interactions between users, human sales associates, help desk staff members, product experts, and AI virtual assistants. Information articles and questions covering products and services offered for sale by the website can be included in the LLM database. The information on products can be analyzed by the LLM and used to generate answers to questions and comments related to products and services offered for sale. In embodiments, the first user can ask a question for which the LLM has no relevant information. For example, the first user can ask about the available sizes of a shirt. When the LLM analyzes the question and performs a search for the shirt sizes, it can find that this information does not reside in the knowledge base. The LLM can contain a set of standard responses to address instances where requested information is missing or has been flagged as incorrect. For example, the LLM can respond with “Sorry, I don't know the answer to that question” or “Please give me a few minutes to find the answer for you.”

The flow 100 includes producing 140 a video segment, wherein the video segment includes a performance by a synthetic human, wherein the performance is based on the response that was created. In embodiments, the LLM response can be forwarded to one or more processors that have a copy of a 3D image of the synthetic human and access to a game engine. The image of the synthetic human can be combined with the synthesized voice and used to generate a video clip of the synthetic human performing the LLM response. In some embodiments, video clips of standard answers can be produced and stored for use when additional time is required to produce a response or when no information is available, for example. As responses about products and services are generated and videos are produced, a library of video responses can be accumulated and stored so that when the same or similar questions are asked by other users, the relevant video can be accessed and presented to the user.

The flow 100 includes presenting 150, to the first user, within the embedded interface, the video segment that was produced. In embodiments, as the video segment is generated, it can be presented immediately to the first user. The embedded interface can display the assembled video segment performed by the synthetic human in a webpage window, video chat window, etc. In embodiments, as the user views the video segment and generates additional questions or comments, the capturing of user comments, LLM processing, video producing, and presenting cycle can be repeated. The user can continue to interact with the synthetic human, generating additional input collected by the embedded interface. The collecting of user input, creating a response, producing related video clips, and presenting to the user can continue, so that the interaction between the user and the synthetic human can appear as natural as two humans interacting within a video chat.

The flow 100 includes capturing 160 a second input, from the first user, wherein the second input is responsive to the presenting. In embodiments, as the first user views the first video response and produces additional questions or comments, the input from the user can be collected by the embedded interface, converted into text, and evaluated by the LLM. In embodiments, a natural language processing (NLP) engine can be included in the LLM. NLP is a category of artificial intelligence (AI) concerned with interactions between humans and computers using natural human language. NLP can be used to develop algorithms and models that allow computers to understand, interpret, generate, and manipulate human language. In embodiments, the large language model (LLM) can use NLP to understand the text and the context of voice and text communication during the interaction. NLP can be used to detect one or more topics discussed by the user and synthetic human. Evaluating a context of the interaction can include determining a topic of discussion; understanding references to and information from other websites; understanding products for sale or product brands; and evaluating livestream hosts associated with a brand, product for sale, or topic.

The flow 100 includes evaluating 162, by the LLM, the response that was created, wherein the evaluating is based on the second input. In embodiments, the second input from the first user can include one or more requests for additional information, requests for clarification of the first response, expressions of emotion, a request to purchase one or more products, moving to a different webpage, leaving the website, and so on. For example, the first user input can be a question about the available colors of a product. The AI virtual assistant can respond with the list of colors available based on a response generated by the LLM. The user can then ask about sizes of the product, the AI virtual assistant can respond with the sizes available, and so on. Each response of the AI virtual assistant can lead to another question until the user makes a purchase decision, becomes interested in a different product, and so on. In another example, the user may choose to purchase the product because he or she needs no additional information. Or the user may decide not to purchase because the color or size of the product is not to their liking. In some cases, the second input from the user can be an expression of confusion, exasperation, or another negative emotional response. The LLM can evaluate this type of second input as an indication that the first LLM response was erroneous, incomplete, deficient, and so on. The user can also leave the product webpage or the website entirely. The LLM can also evaluate this event as an indication of a problem with its first response to the user. In embodiments, the user can ask a question or make a comment that indicates the first LLM response was incorrect or incomplete. For example, the second input from the user can be something like, “You're talking about the wrong product” or “What does that mean?” or “I don't understand” and so on.

The flow 100 includes constructing 164, by the LLM, a second response to the second input, wherein the second response is based on the product information within the product knowledge base, wherein the response is responsive to the second input. In embodiments, the producing and the presenting can include the second response. As mentioned above and throughout, the second user input can include a variety of questions and comments. As the LLM analyzes the second user input, one or more responses can be generated and used to produce a video segment that can be performed by the synthetic host and presented to the user. In embodiments, the second response can be an answer to a second question asked by the user, a link to a short-form video demonstration of a product, a webpage enabling product purchases, and so on. The LLM can access the correct information from the product knowledge base and generate a response to the user's second input. The interaction between the user and the synthetic human can go on for several iterations as the LLM generates responses to questions and comments from the user. In some embodiments, one or more additional users can be interested in the same product or group of products at the same time. A livestream can be created to allow the synthetic host to respond to many users interested in the same product, as well as allowing users to interact with one another.

In embodiments, as the LLM evaluates 162 responses from the user, missing or incorrect product information can be identified. The user can ask questions for which the LLM has no relevant information stored in the knowledge base. The information can be missing or previously marked as incorrect based on responses from other users, product experts, salespeople, vendor websites, and so on. The LLM can construct responses that indicate to the user that the requested information is unavailable or that additional time may be required to acquire the information. For example, the LLM can construct a second response such as “Sorry, I don't know the answer to that question” or “Please give me a few minutes to find the answer for you.”

The flow 100 includes self-improving 170, by the LLM, the product knowledge base, wherein the self-improving is based on the evaluating, and wherein the self-improving relates to the product information 172. In embodiments, the self-improving comprises determining a quality metric 174, wherein the determining is based on the second input. The quality metric can be based on a relevance of the response. The quality metric can be based on an accuracy of the response. The quality metric can include a tone of the second input. The quality metric can include a lack of positive feedback in the second input. In embodiments, the quality metric can include statistics to indicate the number of positive and negative responses to answers generated by the LLM for products stored in the knowledge base. A threshold can be established to indicate when a search for additional information on a product can be initiated. The quality metric can be stored in the product knowledge base 178. Each product entry in the knowledge base can be associated with responses that have been presented and for which quality metrics have been determined. The self-improving can further comprise revising the product information 176, wherein the revising is based on the quality metric.

The flow 100 includes updating product information 180 within the product knowledge base. In embodiments, the updating includes an unstructured text. The updating can include multimedia data. The multimedia data can include one or more videos. The updating can further comprise capturing a context 182 of the one or more videos. In embodiments, the capturing includes transcribing the one or more videos 184. The capturing can include extracting objects 186 from the one or more videos, wherein the extracting is accomplished by machine learning. The context can be saved in the product knowledge base 188. In embodiments, the product information within the product knowledge base can be updated with information from text, video, audio, or other sources that relate to a product or service for sale on the website or application. Audio files can be converted to text to allow analysis by the LLM to identify information points such as prices, colors, fabrics, and so on. Scanned printed materials can be analyzed for visual and text information. Videos can be analyzed for product images and audio information that can be transcribed, analyzed and stored separately, or included as metadata associated with one or more related products. For example, a vendor can generate a print advertisement that relates to a sale on certain products in their inventory. A specific set of shirts, for example, can be part of a 20% off sale for the month of February. The sale may be limited to particular sizes, colors, patterns, etc. The sale price may only be available through the vendor's website. The specifics of the advertisement can be captured by machine learning and added to the product knowledge base. User questions related to the shirts being offered for sale can be answered by the LLM by referencing information captured from the print advertisement. Photos of the shirts included in the print advertisement can be used by the LLM and added to the response presented by the AI virtual assistant. Information about the shirt sizes, discount, dates of the sale, and so on can be included in the response presented by the AI virtual assistant.

In embodiments, the LLM analysis can include information about the context 182 of the print advertisement and the sales campaign it presents. In the example, the 20% off sale applies to a specific set of shirts, certain sizes of those shirts, and is only available in February. These specifics can be stored and applied to responses generated by the LLM. For example, a user can ask if the 20% off pricing applies to pants or other clothing items. The information in the product knowledge base can be used to respond that the discounted price applies only to certain shirts and is not available for pants for sale on the website. Another user can ask whether the discounted price is available in stores operated by the vendor or third parties. The response generated by the LLM can include information from the print advertising that states that the discounted price is only available through the website, and so on.

The updating can further comprise determining a structure 190 to store the product information. In embodiments, the structure can include an embedding store. Embeddings can be numerical representations of real-world objects that capture inherent properties and relationships between real-world data. Embeddings can include vectors which can be a set of numerical values in a multidimensional space. For example, embeddings can be generated from a picture of a human face. The embeddings can include eye color; distance between eyes and nose; location of freckles; thickness of eyebrows; color, length, and style of hair; and so on. These embeddings can be stored as multidimensional vectors and used to train a machine learning model. Later, the machine learning model can perform a multidimensional search on the stored vectors to determine how similar a second photo of a human is to the first human, making a judgment as to whether it is a photo of the same person.

The product information can be stored with an embedding store structure. Thus, multidimensional data can be stored in vector format for any information pertaining to the product. This information can include structured text, unstructured text, photos, videos, brochures, and so on. The vector information can be used to train a machine learning model. The model can then determine how relevant information in the embedded store is to a user question by performing a multidimensional search of the embedding store. If the relevance is above a threshold, the machine learning model can use the information in the embedded store as it is creating a response to the first input from the first user. Thus, in embodiments, the creating comprises a multidimensional search on one or more vectors associated with the embedding store.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

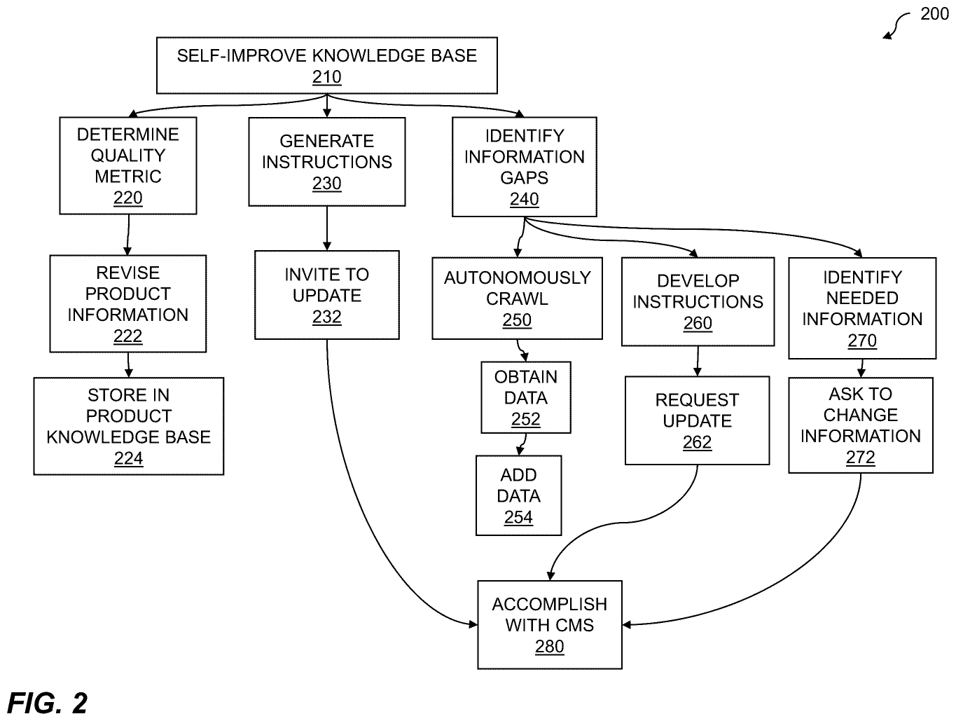

FIG. 2 is a flow diagram for self-training an artificial intelligence virtual assistant. The flow 200 includes self-improving 210, by the LLM, the product knowledge base, wherein the self-improving is based on the evaluating, and wherein the self-improving relates to the product information. In embodiments, the self-improving can comprise determining a quality metric 220, wherein the determining is based on the second input. The quality metric can be based on a relevance of the response. For example, if a user asks about the price of an item, does the LLM response contain a monetary value related to the product? The quality metric can be based on an accuracy of the response. For example, does the price contained in the LLM response agree with prices for the same product from other information sources? The quality metric can be based on the completeness of the response. For example, does the LLM response include price information related to sizes, alternate patterns or colors, etc.? Are shipping costs included? The quality metric can be based on the consistency of the response. For example, is the cost of a shirt included in an LLM response close to other shirts in the same category? The quality metric can be based on the timeliness of the response. For example, was the price of a shirt found quickly and sent to the user in an LLM response rapidly? The quality metric can include a tone of the second input. The quality metric can include a lack of positive feedback in the second input. For example, was the tone or emotional content of the user positive or negative in the second input? Did the user ask a clarifying question or say something to indicate that the initial LLM response was not helpful or relevant? In embodiments, the quality metric can include statistics to indicate the number of positive and negative responses to answers generated by the LLM for products stored in the knowledge base. A threshold can be established to indicate when a search for additional information on a product can be initiated. Numeric values can be assigned to the quality metric criteria. As user responses accumulate, the quality of LLM responses regarding products can be aggregated and refined to determine when additional information for a product needs to be located and stored. The quality metric can be stored in the product knowledge base 224. Each product entry in the knowledge base can be associated with responses that have been presented and for which quality metrics have been determined.

The self-improving can further comprise revising the product information 222, wherein the revising is based on the quality metric. In embodiments, a threshold can be used to determine when product information needs to be added or updated. For example, when 500 users ask for information about the type of fabric used in a carpet and the second input from 400 of the users indicates that the first LLM response was not helpful, the quality metric related to the carpet product can be sufficiently low to cause the information to be added or revised. The quality metric can be stored in the product knowledge base 224. Each product entry in the knowledge base can be associated with responses that have been presented and for which quality metrics have been determined.

The self-improving can comprise generating one or more self-learning instructions 230. The one or more self-learning instructions include inviting a seller of the one or more products for sale to update the product information 232 within the product knowledge base, wherein the update is accomplished with a client management system (CMS) 280. In embodiments, the LLM training process can identify information gaps in the product information knowledge base. The quality metrics related to a product can identify information gaps or inaccuracies in the product information knowledge base. As the need for new or updated information is identified, instructions can be generated to invite a human product expert, salesperson, sales manager, or other staff person to add the needed information to the product knowledge base using a client management system. In embodiments, the instructions can be sent to the product salesperson by email, text, audio message, video message, or within the CMS application. In embodiments, the instructions can include product names, product numbers, SKUs, and so on to identify the product. The instructions can identify the product information to be added, updated, validated, or corrected based on the information gaps and/or quality metric values.

The self-improving can comprise identifying a pattern of information gaps 240, wherein the identifying is based on one or more interactions with the one or more users. In embodiments, the collecting, the creating, the producing, the presenting, and the capturing comprise an interaction. As users interact with the AI visual assistant about products, gaps in the information about products can be identified. For example, a high percentage of second user inputs that indicate confusion or dissatisfaction with LLM responses to questions about the dimensions of a kitchen cabinet can indicate that the measurements of the cabinet are either missing or incomplete.

The self-improving can further comprise autonomously crawling 250, by the LLM, one or more third party websites, wherein the autonomous crawling is based on the pattern of information gaps, wherein the autonomous crawling obtains data 252 about the one or more products for sale. In embodiments, websites that contain information about products with identified information gaps can be searched. Search algorithms can be used to identify related information on multiple websites. Autonomous crawling can use artificial intelligence (AI) and machine learning algorithms to identify multiple criteria related to information gaps in products and can match data located on multiple websites to fill in the information gaps. As information gaps are identified and the correct information is obtained and added to the product knowledge base 254, the crawling process improves. The autonomous searches become more efficient in identifying the websites most likely to contain the required data and in locating the data within the selected websites. In embodiments, the self-improving further comprises adding, in the product information, the data that was obtained.

The self-improving can further comprise developing, by the LLM, a plurality of self-learning instructions 260, wherein the developing is based on the pattern of information gaps. The plurality of self-learning instructions can be based on statistical analysis. The plurality of self-learning instructions can include requesting 262 that a seller of the one or more products within the product knowledge base update the product information, wherein the requesting is based on the first input, and wherein the update is accomplished with a client management system (CMS) 280. As the self-improving process identifies, locates, and updates information in the product knowledge base, the types and quality of information supplied by digital and human sources can be collected and used to improve the efficiency of data acquisition. For example, gaps related to information about sales, discounts, product availability, and so on that can be most easily answered by a person working for the vendor website can be used to develop instructions for a salesperson that can respond using a CMS. The self-improving can further comprise identifying 270, in the product knowledge base, needed product information, wherein the needed product information relates to the one or more products for sale, wherein the identifying is based on the pattern of information gaps. In embodiments, the needed product information comprises missing information. The needed information can comprise inconsistent information. The self-improving can further comprise asking a seller of the one or more products for sale within the product knowledge base to change the product information 272, wherein the asking is based on the identifying, and wherein the change is accomplished with a client management system (CMS).

In embodiments, product information that is missing, incorrect, or inconsistent can be updated by the self-improvement process using information gathered from websites using an autonomous crawl process and/or human product experts and salespeople using a client management system (CMS). As the self-improvement process adds and updates product information, the machine learning engine becomes better at routing requests for product data to human and/or web-based sources. For example, product information such as weights, colors, sizes, dimensions, and so on can be more easily and accurately obtained from vendor or supplier websites. Sales campaigns, product availability, shipping options, inventory details, and so on can be more easily updated by local sales staff through a CMS. In some embodiments, key data elements such as prices, sizes, and so on can be flagged by the LLM training process so that any missing key element can be immediately forwarded to the CMS for updating.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

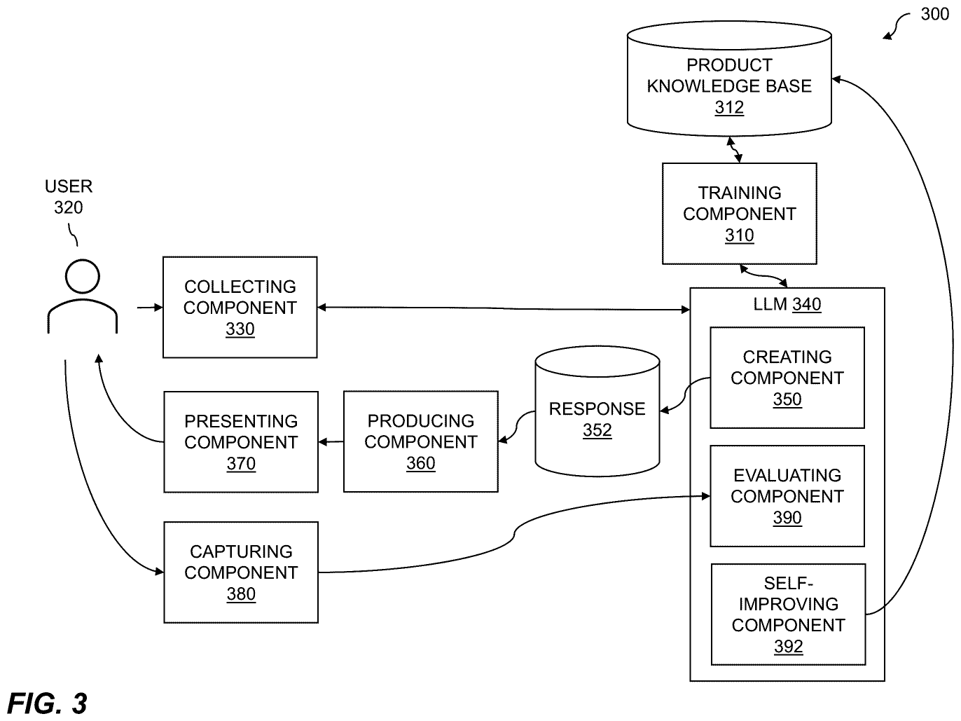

FIG. 3 is an infographic for self-improving interactions with an artificial intelligence virtual assistant. The infographic 300 includes training 310 a large language model (LLM) 340, wherein the training includes product information, wherein the product information resides within a product knowledge base 312, and wherein the product information relates to one or more products for sale. In embodiments, the LLM can be trained with voice and text interactions between users, human sales associates, help desk staff members, product experts, and synthetic humans. Information articles and questions covering products and services offered for sale by the website can be included in the product knowledge base 312. The knowledge base can hold any type of information related to the products and services offered by the website. The data can be structured text, unstructured text, documents, videos, service or user manuals, sales flyers, brochures, short-form videos, video clips from websites, and so on. The information on products in the knowledge base can be analyzed by the LLM 340 and used to generate answers to questions and comments related to products and services offered for sale.

In embodiments, the training component comprises recognizing incorrect information within the product knowledge base. As user questions are received by the LLM and responses are generated based on information in the product knowledge base, the quality of the responses can be measured and used to determine whether additional product information can be added. In embodiments, the LLM training process can recognize products with an information quality metric below a threshold, due to missing or incorrect information stored in the knowledge base, and can initiate the self-improving component 392 in order to update and/or correct the product information.

The infographic 300 includes a collecting component 330. The collecting component 330 includes collecting, by an embedded interface, input from one or more users 320, wherein the input from one or more users is related to the one or more products for sale, wherein the embedded interface includes a synthetic human, and wherein the input from one or more users includes a first input from a first user. In embodiments, the embedded interface can comprise an app running on a mobile device such as a smartphone, tablet, and so on. In embodiments, the embedded interface can comprise a website. The website can be an ecommerce site for a single vendor or brand, a group of businesses, a social media platform, and so on. The website can be displayed on a portable device. The portable device can be an Over-the-Top (OTT) device such as a mobile phone, laptop computer, tablet, or pad. The accessing of the website can be accomplished using a browser running on a device. In embodiments, the embedded interface can comprise an app running on a mobile device. The app can use HTTP, TCP/IP, or DNS to communicate with the Internet, web servers, cloud-based platforms, and so on.

In embodiments, an image of a live human can be captured from media sources including one or more photographs, videos, livestream events, and livestream replays, including the voice of the livestream host. The images of the live human can be isolated and combined in an AI machine learning model into a 3D model that can be used to generate one or more video segments in which the synthetic human performs questions, comments, and answers generated by the large language model (LLM) 340. In embodiments, the user 320 can request an interaction with the synthetic human by clicking on an icon or button displayed in the embedded interface or on a help button on a webpage, asking for help in a text chat box, navigating to a help desk screen, pressing a phone button during a call, submitting an email to a help desk address, and so on. The user can initiate an interaction from the main webpage of a website, a help menu page, a webpage presenting a specific product, a text or video chatbot embedded in the website, and so on. In embodiments, the audio input generated by the user interacting with the synthetic human can be collected and converted into text. The conversion can be accomplished using an online conversion application, AI transcription service, automatic speech recognition (ASR) application, and so on.

The infographic 300 can include a creating component 350. The creating component 350 includes creating, by the LLM 340, a response 352 to the first input from a first user 320, wherein the response is based on the product information within the product knowledge base 312, wherein the response is responsive to the first input from a first user. As mentioned above and throughout, the LLM can be trained with voice and text interactions between users, human sales associates, help desk staff members, product experts, and AI synthetic humans. Information articles and questions covering products and services offered for sale by the website can be included in the LLM database. The information on products can be analyzed by the LLM and used to generate answers to questions and comments related to products and services offered for sale. In embodiments, the LLM responses can include situations in which the LLM has no information. In some embodiments, responses that have been generated for previous users to the same or similar questions about the same products can be stored and used by the LLM in order to answer the first user input more quickly.

The infographic 300 includes a producing component 360. The producing component 360 includes producing a video segment, wherein the video segment includes a performance by a synthetic human, wherein the performance is based on the response 352 that was created. In embodiments, the LLM response can be forwarded to one or more processors that have a copy of a 3D image of the synthetic human and access to a game engine. The image of the synthetic human can be combined with a synthesized voice and used to produce a video clip of the synthetic human performing the LLM response. In some embodiments, video clips of standard answers can be produced and stored for use when additional time is required to produce a response or when no information is available. As responses about products and services are generated and videos are produced, a library of video responses can be accumulated and stored so that when the same or similar questions are asked by other users, the relevant video can be accessed and presented to the user.

The infographic 300 includes a presenting component 370. The presenting component 370 includes presenting, to the first user, within the embedded interface, the video segment that was produced. In embodiments, as the video segment is generated, it can be presented immediately to the first user 320. The embedded interface can display the assembled video segment performed by the synthetic human in a webpage window, video chat window, etc. In embodiments, as the user views the video segment and generates additional questions or comments, the collecting of user comments, LLM processing, video producing, and presenting can be repeated. The user can continue to interact with the synthetic human, generating additional input collected by the embedded interface.

The infographic 300 includes a capturing component 380. The capturing component 380 includes capturing a second input, from the first user 320, wherein the second input is responsive to the presenting 370. In embodiments, as the first user views the first video response and produces additional questions or comments, the input from the user can be collected by the embedded interface, converted into text, and evaluated by the LLM. A natural language processing (NLP) engine can be included in the LLM. NLP can be used to develop algorithms and models that allow computers to understand, interpret, generate, and manipulate human language. In embodiments, the large language model (LLM) 340 can use NLP to understand the text and the context of voice and text communication during the interaction. NLP can be used to detect one or more topics discussed by the user and synthetic human. Evaluating a context of the interaction can include determining a topic of discussion; understanding references to and information from other websites; understanding products for sale or product brands; and identifying livestream hosts associated with a brand, product for sale, or topic.

The infographic 300 includes an evaluating component 390. The evaluating component 390 includes evaluating, by the LLM 340, the response that was created, wherein the evaluating is based on the second input. In embodiments, the captured second input from the first user 320 can include one or more requests for additional information, requests for clarification of the first response, expressions of emotion, a request to purchase one or more products, moving to a different webpage, leaving the website, and so on. The LLM can generate a response to the captured user input. Each response of the AI virtual assistant can lead to another question until the user decides to purchase the product or becomes interested in a different product. In embodiments, the second input from the user can be an expression of confusion, exasperation, or another negative emotional response. The LLM can evaluate this type of second input as an indication that the first LLM response was erroneous, incomplete, or deficient in some other way. The user can also leave the product webpage or the website entirely. The LLM can also evaluate this event as an indication of a problem with its first response to the user. In embodiments, the user can also ask a question or make a comment that indicates that the first LLM response was incorrect or incomplete.

The infographic 300 includes a self-improving component 392. The self-improving component includes self-improving, by the LLM 340, the product knowledge base, wherein the self-improving is based on the evaluating, and wherein the self-improving relates to the product information. In embodiments, the self-improving comprises determining a quality metric, wherein the determining is based on the second input. The quality metric can include statistics to indicate the number of positive and negative responses to answers generated by the LLM for products stored in the product knowledge base 312. A threshold can be established to indicate when a search for additional information on a product can be initiated. The quality metric can be stored in the product knowledge base. Each product entry in the knowledge base can be associated with responses that have been presented and for which quality metrics have been determined. The self-improving can further comprise revising the product information, wherein the revising is based on the quality metric.

The infographic 300 can include updating product information within the product knowledge base 312. In embodiments, the updating can include an unstructured text. The updating can include multimedia data. The multimedia data can include one or more videos. In embodiments, the product information within the product knowledge base can be updated with information from text, video, audio, or other sources that relate to a product or service for sale on the website or application. Audio files can be converted to text to allow analysis by the LLM; to identify information points such as prices, colors, and fabrics; and so on. Scanned printed materials can be analyzed for visual and text information. Videos can be analyzed for product images and audio information that can be transcribed, analyzed, and stored separately, or included as metadata related to one or more related products.

In embodiments, instructions can be generated to invite a human product expert, salesperson, sales manager, or other staff person to add or update product information to the product knowledge base 312 using a client management system (CMS). In embodiments, the instructions can be sent to the product salesperson by email, text, audio message, video message, or within the CMS application. The instructions can include product names, product numbers, SKUs, and so on to identify the product. The instructions can identify the product information to be added, updated, validated, or corrected based on the information gaps and/or quality metric values.

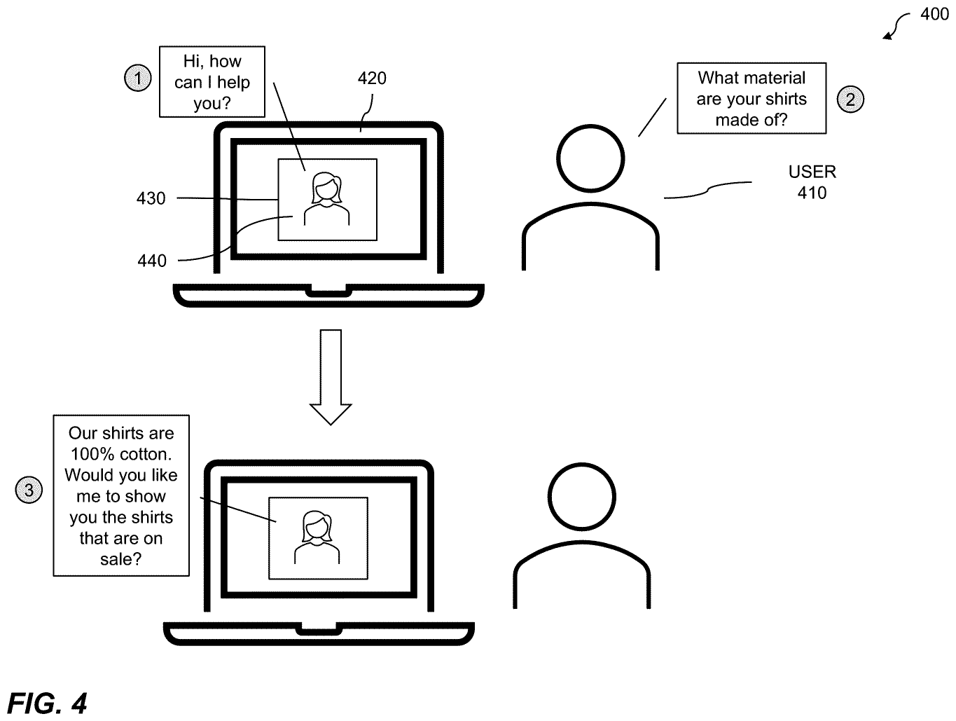

FIG. 4 is an example of an interaction with an artificial intelligence virtual assistant. The example 400 is shown in three stages. In stage 1, the example 400 includes requesting, by a user 410, an interaction, wherein the interaction is based on a product for sale within the one or more products for sale. The user accesses a website with products for sale via an embedded interface 420. The embedded interface recognizes a user request for an interaction, based on the user clicking on a help button, asking for more information in a video or audio chat, asking a question in a text box, etc. In some embodiments, information about the user is collected based on previous user interactions with the website, demographic data available from the video chat, social media platforms, search engine information, and so on. An AI machine learning model uses the user information to select a synthetic human 440 to interact with the user 410 through a first video segment 430 displayed in the embedded interface 420. In the example 400, the synthetic human is shown saying, “Hi, how can I help you?”

In stage 2 of the example 400, the user 410 responds to the synthetic human in the first video segment with a question, “What materials are your shirts made of?” The example 400 includes collecting, by the embedded interface 420, the user audio input. The user input, for example, the question about shirt material, is collected by an AI machine learning model that includes a large language model (LLM) that uses natural language processing (NLP). In some embodiments, the AI machine learning model analyzes the user input and generates a response based on information articles contained in a dataset such as the Stanford Question and Answering Dataset (SQuAD). The SQuAD dataset can be formatted to contain hundreds of questions and answers generated from the information articles on products and services offered for sale on the website. The AI machine learning model can analyze the question asked by the user and select the best response based on the product information stored in the dataset.

The example 400 includes creating, by an LLM, a response to the interaction with the user. In stage 3 of the example 400, the LLM generates a text response to the user question. The response is, “Our shirts are 100% cotton. Would you like me to show you the shirts that are on sale?” The entire text response is generated using the same voice of the synthetic human used in the first video segment (Stage 1) to create an audio stream. In embodiments, the audio stream can be edited to include pauses, speaking errors, accents, idioms, and so on to make the audio sound as natural as possible. The audio stream can be separated into segments based on the natural auditory cadence of the stream. Each segment is used to generate a video clip of the synthetic human host performing the audio segment. The audio segments are sent to one or more separate processors so that each video clip can be generated quickly and reassembled in order to be presented to the user. In embodiments, the video clips can be produced and presented to the user as additional clips are being generated. The user 410 can respond to the second video clip with additional questions, comments, and so on. For example, the user in the example 400 can say, “Yes, please do.” The AI machine learning model can then collect the response from the user and display the shirts on sale from the website. Additional videos of the synthetic human can be generated to discuss additional details of the shirts; inform the user about matching clothing items such as pants, jackets, accessories, and so on.

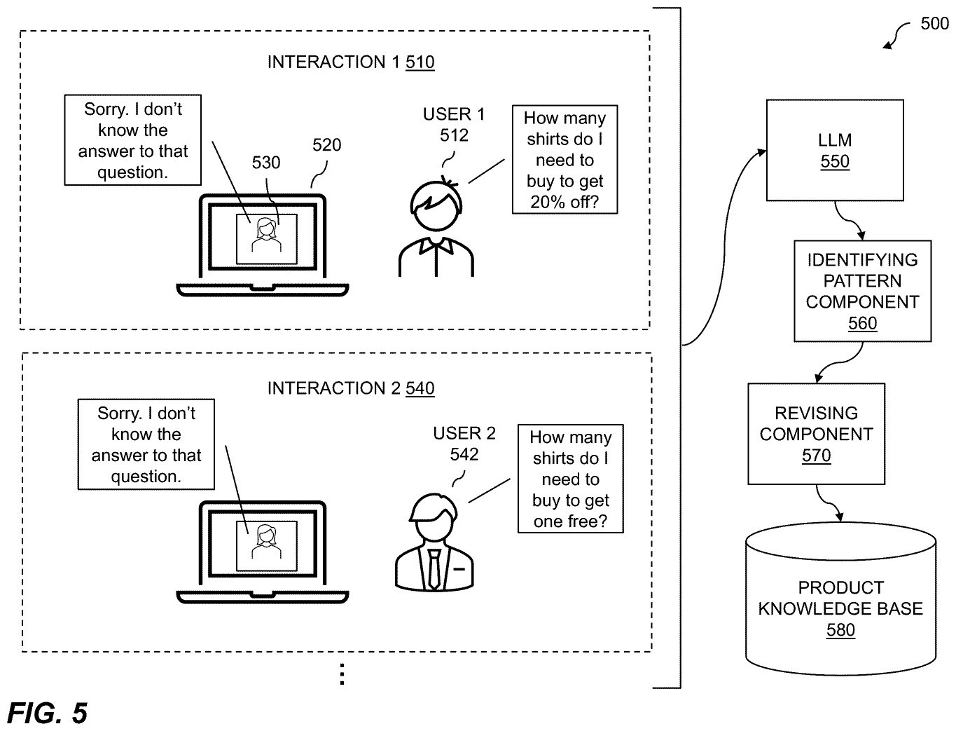

FIG. 5 is an infographic for revising a product knowledge base based on a pattern of information gaps. The infographic 500 includes collecting, by an embedded interface 520, input from one or more users 512, wherein the input from one or more users is related to the one or more products for sale, wherein the embedded interface includes a synthetic human 530, and wherein the input from one or more users includes a first input from a first user. The infographic 500 shows two interactions between the user and a synthetic human. Interaction 1 510 shows the user 512 asking a question, “How many shirts do I need to buy to get 20% off?” The embedded interface 520 can collect the question as input generated by the user and submit it to the LLM 550 for analysis. In embodiments, the audio input from the user can be converted to text and submitted to the LLM for analysis.

The infographic 500 can include identifying a pattern of information gaps 560, wherein the identifying is based on one or more interactions 510 with the one or more users. In embodiments, the identifying can comprise self-improving, by the LLM 550, wherein the self-improving relates to the product information that can be included in the product knowledge base 580. In embodiments, the LLM can identify information that is missing from the product knowledge base related to one or more products for sale. In the infographic 500, the synthetic human 530 is shown responding to user 1 512 based on an information gap in the product knowledge base. The synthetic human response is, “Sorry, I don't know the answer to that question.” The LLM can search the product knowledge base based on one or more products the user is asking about and determine that sales and discount information is missing. In embodiments, the LLM can generate the response to the user based on missing information when the LLM determines that the information is missing. In some embodiments, LLM responses to address routine interactions can be generated, produced as videos performed by the synthetic human, and stored. When the LLM determines that product information is missing or that more time is required to retrieve information and produce a video response, one or more of the stored videos can be immediately presented to the user. For example, a video showing the synthetic human responding, “Please give me a few minutes to look that up for you,” or “I′m sorry, I don't have that information,” or “Let me find someone who can answer that question for you,” and so on can be produced and stored for presentation to the user.

The infographic 500 can further comprise constructing, by the LLM 550, a second response to the second input, wherein the second response is based on the product information within the product knowledge base 580, wherein the response is responsive to the second input. In embodiments, the collecting, the creating, the presenting, and the capturing can include a second user 542 within the one or more users. In the infographic 500, interaction 2 540 shows a second user 542 asking a similar question related to available discounts on shirts sold through the embedded interface. The user 2 542 is shown asking, “How many shirts do I need to buy to get one free?” As in interaction 1 510 above, the embedded interface can collect the question as input generated by the user and submit it to the LLM 550 for analysis. The user 2 question can be used to identify a pattern of information gaps 560, wherein the identifying is based on one or more interactions 540 with the one or more users. In embodiments, the LLM can identify information that is missing from the product knowledge base related to one or more products for sale. In the infographic 500, the synthetic human is shown responding to user 2 542 based on an information gap in the product knowledge base. The synthetic human response is the same as in interaction 1, “Sorry, I don't know the answer to that question.” The LLM can search the product knowledge base based on one or more products the user is asking about and determine that sales and discount information is missing.

The infographic 500 can include a revising component 570. The revising component 570 can include revising the product information based on the pattern of information gaps identified by the one or more interactions with one of more users. In the infographic 500, two interactions between the synthetic human and two users can identify a pattern of information gaps related to shirts offered for sale on the website. In embodiments, the revising component can generate one or more self-learning instructions. The one or more self-learning instructions can include inviting a seller of the one or more products for sale to update the product information within the product knowledge base 580, wherein the update is accomplished with a client management system (CMS). In the infographic 500, one or more sales associates, product experts, vendor representatives, etc. can be notified by email, text message, voice message, video chat, or through the CMS application that a discount or other information related to the shirts is missing. The salesperson can obtain the information and enter it into the product knowledge base 580 through the CMS application. In other embodiments, autonomous crawling, by the LLM, can be applied to one or more third party websites, wherein the autonomous crawling is based on the pattern of information gaps 560, wherein the autonomous crawling obtains data about the one or more products for sale. The data obtained can be added to the product knowledge base 580. For example, the shirt vendor website can be searched by autonomously crawling, and pricing and discount information related to the shirts can be obtained and added to the product knowledge base 580.

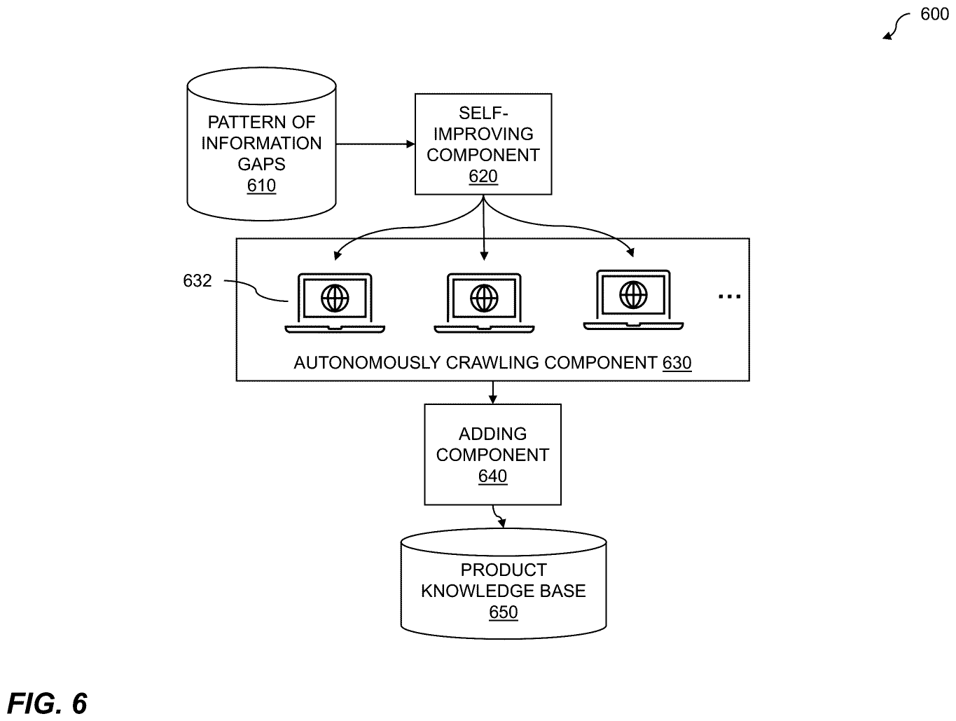

FIG. 6 is an infographic for autonomously crawling third-party websites. The infographic 600 can include identifying a pattern of information gaps 610, wherein the identifying is based on one or more interactions with the one or more users. As users interact with the synthetic human about products, gaps in the information about products can be identified. For example, a high percentage of user inputs that indicate confusion or dissatisfaction with responses to questions about the dimensions of a kitchen cabinet can indicate that the measurements of the cabinet are either missing or incomplete. User inputs that contain requests for the same information requested in previous inputs can also indicate information gaps. In some embodiments, the LLM training process can identify information gaps by comparing data elements present in similar products that are missing. For example, product information regarding wall paint from one vendor includes coverage estimates, drying time, number of coats recommended, minimum and maximum room temperatures during application, and so on. Product information for wall paint from another manufacturer does not include coverage estimates or drying time. The LLM training process can identify the drying time and coverage estimates as information gaps for the wall paint product and can forward the information gaps to the self-improving component 620.

The infographic 600 can include a self-improving component 620. The self-improving component 620 can include autonomously crawling 630, by the LLM, one or more third party websites 632, wherein the autonomous crawling can be based on the pattern of information gaps 610, wherein the autonomous crawling can obtain data about the one or more products for sale. In embodiments, third party websites that contain information about products with identified information gaps can be searched. The websites can include manufacturer sites, social media platforms, livestreams, product expert sites, and so on. Search algorithms can be used to identify related information on multiple websites. Autonomous crawling can use artificial intelligence (AI) and machine learning algorithms to identify multiple criteria related to information gaps in products and can match data located on multiple websites to fill in the information gaps. As information gaps are identified and related information is obtained and added to the product knowledge base, the crawling process improves. The autonomous searches become more efficient in identifying the websites most likely to contain the required data and in locating the data within the selected websites.

The infographic 600 can include an adding component 640. The adding component 640 can further comprise adding, in the product information, the data that was obtained. The product information can include any type of information related to the products and services offered by the website. The data can be structured text, unstructured text, documents, videos, service or user manuals, sales flyers, brochures, short-form videos, video clips from websites, and so on. In embodiments, the product information resides within a product knowledge base 650.

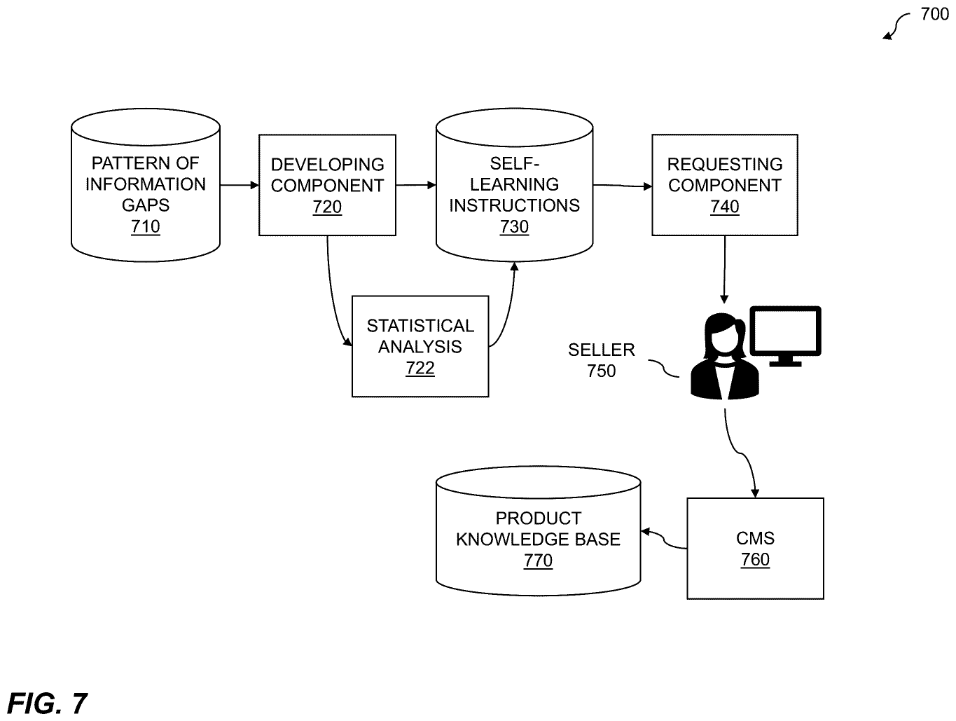

FIG. 7 is an infographic for updating a product knowledge base by a seller with a client management system. The infographic 700 can include identifying a pattern of information gaps 710, wherein the identifying can be based on one or more interactions with the one or more users. As mentioned above and throughout, as users interact with the synthetic human about products, gaps in the information about the products can be identified. User responses that indicate confusion, anger, or frustration can indicate information gaps. User inputs that contain comments about the quality or relevance of an LLM response can indicate information gaps. One or more similar questions that cannot be answered accurately by the LLM can indicate information gaps. The LLM can identify information gaps by identifying inconsistent or incorrect information in the product knowledge base 770. Many other ways to identify information gaps are possible. User inputs that contain repeated requests for information can indicate information gaps, and so on. In some embodiments, the LLM training process can identify information gaps by comparing data elements present in similar products in the knowledge base.

The infographic 700 can include a developing component 720. The developing component 720 can further comprise developing, by the LLM, a plurality of self-learning instructions 730, wherein the developing is based on the pattern of information gaps 710. The plurality of self-learning instructions can include requesting 740, of a seller 750 of the one or more products within the product knowledge base 770, to update the product information, wherein the requesting is based on the first input, and wherein the update is accomplished with a client management system (CMS) 760. As the need for new or updated information is identified by a pattern of information gaps, instructions can be generated to invite a human product expert, salesperson, sales manager, or other staff person to add the needed information to the product knowledge base using a client management system. In embodiments, the instructions can be sent to the product salesperson by email, text, audio message, video message, or within the CMS application. In embodiments, the instructions can include product names, product numbers, SKUs, and so on to identify the product. The instructions can identify the product information to be added, updated, validated, or corrected based on the information gaps and/or quality metric values.

In embodiments, the plurality of self-learning instructions can be based on statistical analysis 722. For example, the LLM can count the number of times a question about a product cannot be answered. A threshold can be set so that, for example, when 100 users cannot get an answer to a product question about sizes, self-learning instructions 730 are generated requesting a seller to obtain information about the available product sizes and add it to the product knowledge base using the CMS 760 application. The statistical analysis can include the number of times the same question is asked by one or more users, the number of times users leave the website or the webpage for a product after an LLM response is presented to the user, the number of times a product is purchased after an LLM response is presented, and so on. In embodiments, the statistical analysis parameters can be set by the seller and/or the website administrators.

As the self-improving process identifies, locates, and updates information in the product knowledge base 770, the types and quality of information supplied by digital and human sources can be collected by a machine learning model and used to improve the efficiency of data acquisition. For example, gaps related to information about sales, discounts, product availability, and so on that can be most easily answered by a seller 750 working for the vendor website can be used to develop instructions for the seller that can respond using a CMS 760. The self-learning can further comprise identifying, in the product knowledge base, needed product information, wherein the needed product information relates to the one or more products for sale, wherein the identifying is based on the pattern of information gaps. In embodiments, the needed product information comprises missing information. The needed information can comprise inconsistent information.

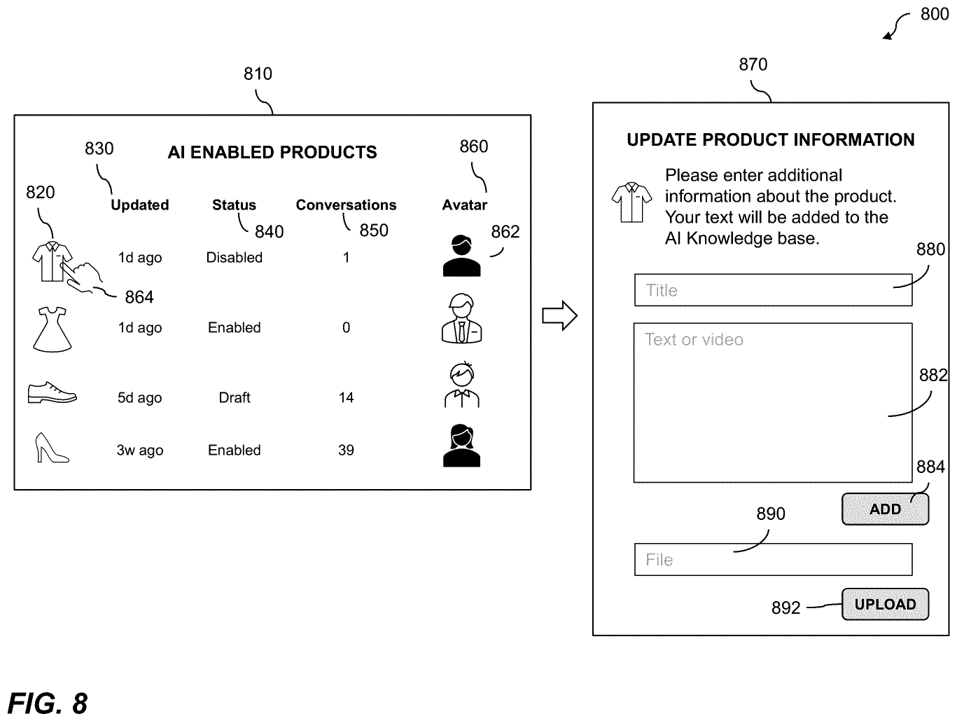

FIG. 8 is an example of a client management system (CMS). The example 800 can include a user display 810 that can present a list of products stored in a product knowledge base. The list of products can include an icon or image of each product 820. The icon or image can be acquired from a still photograph, a digital image, a scanned print advertisement, a video frame, and so on. In some embodiments, the CMS can interface to a digital image scanner or camera to allow the user to take a photo or video of a product for addition to the product knowledge base. In some embodiments, the CMS user can upload a digital image or icon file to be added to the product knowledge base.

In embodiments, the CMS user display 810 can include a time interval indicator 830 to show the amount of time elapsed since the product entry was updated. In embodiments, the updated indicator can use a knowledge base timestamp to determine the amount of time in days, weeks, or months since the product information was updated. In embodiments, the CMS user display can include a status indicator 840 of the product within the product knowledge base. The status indicator 840 can be used to show whether the product is enabled for sale on the website, has been disabled, or remains in draft status, indicating that the product description, product webpage, pricing, or another aspect of the product offering has not yet been completed.

In embodiments, the CMS user display 810 can include a count of the number of conversations 850 between a website user and a synthetic human or AI virtual assistant avatar that have occurred. Each product in the knowledge base can be tracked and updated as website or application users interact with a synthetic human in the embedded interface included on the website. The CMS can use the number of conversations along with other statistics to indicate the success rate of product sales, as well as the number of times conversations resulted in users leaving the website, leaving the product webpage, choosing to interact with a human salesperson, and so on. The number of conversations 850 can be used to indicate when product information needs to be updated. In embodiments, the CMS user interface can include an image of the synthetic human or avatar 860 that is associated with a product in the knowledge base. The AI machine learning model can select one or more synthetic humans or avatars to perform as a salesperson or support staff person presenting a product to one or more users. The CMS can display an image 862 of the avatar associated with the product for the CMS user. In some embodiments, the CMS user can change the avatar associated with a product in the knowledge base. The AI machine learning model can track the sales statistics associated with a product and learn which avatars generate the most successful sales for each product. In some embodiments, the machine learning model can generate different clothes, accessories, hair color, and so on for the avatar in order to refine and improve the sales performance statistics.

The example 800 can include an Update Product Information window 870 to allow the CMS user to update the information for products in the product knowledge base. In embodiments, a product shown in the CMS user display 810 can be selected for updating by using a mouse pointer 864 to highlight or click on the product. The update product information window can include a title 880 for the product. The title bar 880 can include simple text, a short description, such as “This just in!”, and so on. In some embodiments, the title bar can allow text colors, fonts, font sizes, and so on to be selected. In some embodiments, audio files, graphics, text bubbles, and so on can be embedded into the title so that when a website user moves a mouse over them, the added features can be displayed.

In embodiments, the update product information window 870 can include a text or video entry window 882 to allow the CMS user to add or edit a description, digital photograph, or video of the product in the product knowledge base. Products with an existing description or video can be displayed in the entry window and edited by the CMS user. Once a description, photo, or video has been added, an Add button 884 can be selected by the user to write the updates into the product knowledge base. In some embodiments, updates made to an enabled product would be visible to users on the website or application immediately.

In embodiments, the update product information window 870 can include a file selection box 890 to allow a CMS user to upload files into the product knowledge base. The files can also be dragged and dropped into the entry window 882. The files can include product descriptions from a sales or marketing department, digital photos or videos of the product, social media or product expert videos demonstrating the product or giving testimonials, and so on. The update product information window can include an upload button 892 to copy the selected files into the product knowledge base. In embodiments, the CMS user can select files to add to the product knowledge base from a local source such as a thumb drive, CD, DVD, and so on, or from another source within the network to which the CMS belongs. Any information can be added to the entry window 882 or the file selection box 890 including structured text, unstructured text, audio, video, images, and so on. The uploaded information can be used to train the LLM to enhance the LLMs ability to answer a user's questions about the product.

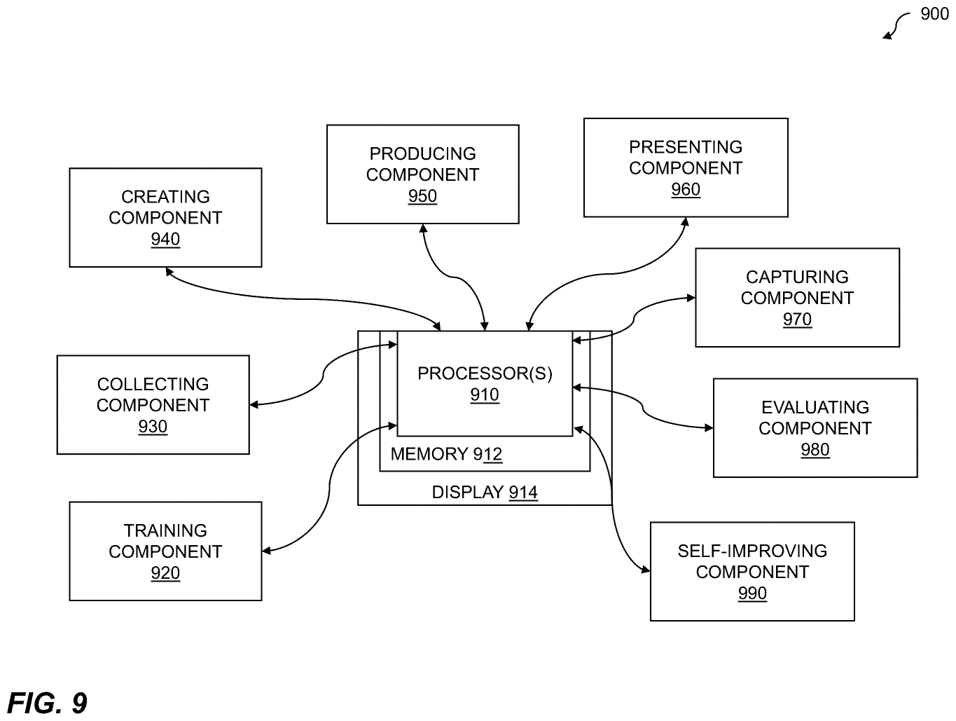

FIG. 9 is a system diagram for self-improving interactions with an artificial intelligence virtual assistant. The system 900 can include one or more processors 910 coupled to a memory 912 which stores instructions. The system 900 can include a display 914 coupled to the one or more processors 910 for displaying data, video streams, videos, video metadata, synthesized images, synthesized image sequences, synthesized videos search results, sorted search results, search parameters, metadata, webpages, intermediate steps, instructions, and so on. In embodiments, one or more processors 910 are coupled to the memory 912 where the one or more processors, when executing the instructions which are stored, are configured to: train a large language model (LLM), wherein the training includes a product information, wherein the product information resides within a product knowledge base, and wherein the product information relates to one or more products for sale; collect, by an embedded interface, input from one or more users, wherein the input from one or more users is related to the one or more products for sale, wherein the embedded interface includes a synthetic human, and wherein the input from one or more users includes a first input from a first user; create, by the LLM, a response to the first input from a first user, wherein the response is based on the product information within the product knowledge base, wherein the response is responsive to the first input from a first user; produce a video segment, wherein the video segment includes a performance by a synthetic human, wherein the performance is based on the response that was created; present, to the first user, within the embedded interface, the video segment that was produced; capture a second input, from the first user, wherein the second input is responsive to the presenting; evaluate, by the LLM, the response that was created, wherein the evaluating is based on the second input; and self-improve, by the LLM, the product knowledge base, wherein the self-improving is based on the evaluating, and wherein the self-improving relates to the product information.

The system 900 includes a training component 920. The training component 920 includes functions and instructions for training a large language model (LLM), wherein the training includes product information, wherein the product information resides within a product knowledge base, and wherein the product information relates to one or more products for sale. In embodiments, the LLM can be trained with voice and text interactions between users, human sales associates, help desk staff members, product experts, and AI virtual assistants. Information articles and questions covering products and services offered for sale by the website can be included in the LLM knowledge base. In embodiments, the knowledge base contains information related to products and services offered by a website or sales application. The knowledge base can hold any type of information related to the products and services offered by the website. The data can be structured text, unstructured text, documents, videos, service or user manuals, sales flyers, brochures, short-form videos, video clips from websites, and so on.

In embodiments, the training comprises recognizing incorrect information within the product knowledge base. As user questions are received by the LLM and responses are generated based on information in the product knowledge base, the quality of the responses can be measured and used to determine whether additional product information can be added. The LLM training process can recognize products with an information quality metric below a threshold, due to missing or incorrect information stored in the knowledge base, and can initiate the self-improvement component in order to update and/or correct the product information.

The system 900 includes a collecting component 930. The collecting component 930 includes functions and instructions for collecting, by an embedded interface, input from one or more users, wherein the input from one or more users is related to the one or more products for sale, wherein the embedded interface includes a synthetic human, and wherein the input from one or more users includes a first input from a first user. In embodiments, the embedded interface can comprise a website. The website can be an ecommerce site for a single vendor or brand, a group of businesses, a social media platform, and so on. The website can be displayed on a portable device. The portable device can be an Over-the-Top (OTT) device such as a mobile phone, laptop computer, tablet, or pad. The accessing of the website can be accomplished using a browser running on a device. In embodiments, the embedded interface can comprise an app running on a mobile device. The app can use HTTP, TCP/IP, or DNS to communicate with the Internet, web servers, cloud-based platforms, and so on.

In embodiments, the user can request an interaction with the synthetic human by clicking on an icon or button displayed in the embedded interface or on a help button on a webpage, asking for help in a text chat box, navigating to a help desk screen, pressing a phone button during a call, submitting an email to a help desk address, and so on. The user can initiate an interaction from the main webpage of a website, a help menu page, a webpage presenting a specific product, a text or video chatbot embedded in the website, and so on. In embodiments, the audio input generated by the user interacting with the synthetic human can be converted into text. The conversion can be done using an online conversion application, AI transcription service, automatic speech recognition (ASR) application, and so on.

The system 900 includes a creating component 940. The creating component 940 includes functions and instructions for creating, by the LLM, a response to the first input from a first user, wherein the response is based on the product information within the product knowledge base, wherein the response is responsive to the first input from a first user. The information on products can be analyzed by the LLM and used to generate answers to questions and comments related to products and services offered for sale. In embodiments, the first user can ask a question for which the LLM has no relevant information. When the LLM analyzes the question and performs a search for information, it can find that the requested information does not reside in the knowledge base. The LLM can contain a set of standard responses to address instances where requested information is missing or has been flagged as incorrect.

The system 900 includes a producing component 950. The producing component 950 includes functions and instructions for producing a video segment, wherein the video segment includes a performance by a synthetic human, wherein the performance is based on the response that was created. In embodiments, the LLM response can be forwarded to one or more processors that have a copy of a 3D image of the synthetic human and access to a game engine. The image of the synthetic human can be combined with the synthesized voice and used to generate a video clip of the synthetic human performing the LLM response. In some embodiments, video clips of standard answers can be produced and stored for use when additional time is required to produce a response or when no information is available, for example. As responses about products and services are generated and videos are produced, a library of video responses can be accumulated and stored so that when the same or similar questions are asked by other users, the relevant video can be accessed and presented to the user.

The system 900 includes a presenting component 960. The presenting component 960 includes functions and instructions for presenting, to the first user, within the embedded interface, the video segment that was produced. In embodiments, as the video segment is generated, it can be presented immediately to the first user. The embedded interface can display the assembled video segment performed by the synthetic human in a webpage window, video chat window, etc.

The system 900 includes a capturing component 970. The capturing component 970 includes functions and instructions for capturing a second input, from the first user, wherein the second input is responsive to the presenting. In embodiments, as the first user views the first video response and produces additional questions or comments, the input from the user can be collected by the embedded interface, converted into text, and evaluated by the LLM. In embodiments, a natural language processing (NLP) engine can be included in the LLM. The large language model (LLM) can use NLP to understand the text and the context of voice and text communication during the interaction. NLP can be used to detect one or more topics discussed by the user and synthetic human. Evaluating a context of the interaction can include determining a topic of discussion; understanding references to and information from other websites; understanding products for sale or product brands; and identifying livestream hosts associated with a brand, product for sale, or topic.

The system 900 includes an evaluating component 980. The evaluating component 980 includes functions and instructions for evaluating, by the LLM, the response that was created, wherein the evaluating is based on the second input. In embodiments, the second input from the first user can include one or more requests for additional information, requests for clarification of the first response, expressions of emotion, a request to purchase one or more products, moving to a different webpage, leaving the web site, and so on. Each response of the AI virtual assistant can lead to another question until the user decides to purchase the product or becomes interested in a different product. In embodiments, the LLM can evaluate the second input as an indication that the first LLM response was erroneous, incomplete, or deficient in some other way. The user can leave the product webpage or the website entirely. The LLM can evaluate this event as an indication of a problem with its first response to the user. In embodiments, the user can ask a question or make a comment that indicates the first LLM response was incorrect or incomplete.

The system 900 includes a self-improving component 990. The self-improving component 990 includes functions and instructions for self-improving, by the LLM, the product knowledge base, wherein the self-improving is based on the evaluating, and wherein the self-improving relates to the product information. In embodiments, the self-improving comprises determining a quality metric, wherein the determining is based on the second input. The quality metric can be based on a relevance of the response. The quality metric can be based on an accuracy of the response. The quality metric can include a tone of the second input. The quality metric can include a lack of positive feedback in the second input. In embodiments, the quality metric can include statistics to indicate the number of positive and negative responses to answers generated by the LLM for products stored in the knowledge base. A threshold can be established to indicate when a search for additional information on a product can be initiated. The quality metric can be stored in the product knowledge base. Each product entry in the knowledge base can be associated with responses that have been presented and for which quality metrics have been determined. The self-improving can further comprise revising the product information, wherein the revising is based on the quality metric.

The self-improving can further comprise updating product information within the product knowledge base. In embodiments, the updating includes an unstructured text. The updating can include multimedia data. The multimedia data can include one or more videos. The updating can further comprise capturing a context of the one or more videos. In embodiments, the capturing includes transcribing the one or more videos. The capturing can include extracting objects from the one or more videos, wherein the extracting is accomplished by machine learning. The context can be saved in the product knowledge base. In embodiments, the product information within the product knowledge base can be updated with information from text, video, audio, or other sources that relates to a product or service for sale on the website or application.

The system 900 can include a computer program product embodied in a non-transitory computer readable medium for evaluation, the computer program product comprising code which causes one or more processors to perform operations of: training a large language model (LLM), wherein the training includes a product information, wherein the product information resides within a product knowledge base, and wherein the product information relates to one or more products for sale; collecting, by an embedded interface, input from one or more users, wherein the input from one or more users is related to the one or more products for sale, wherein the embedded interface includes a synthetic human, and wherein the input from one or more users includes a first input from a first user; creating, by the LLM, a response to the first input from a first user, wherein the response is based on the product information within the product knowledge base, wherein the response is responsive to the first input from a first user; producing a video segment, wherein the video segment includes a performance by a synthetic human, wherein the performance is based on the response that was created; presenting, to the first user, within the embedded interface, the video segment that was produced; capturing a second input, from the first user, wherein the second input is responsive to the presenting; evaluating, by the LLM, the response that was created, wherein the evaluating is based on the second input; and self-improving, by the LLM, the product knowledge base, wherein the self-improving is based on the evaluating, and wherein the self-improving relates to the product information.

The system 900 can include a computer system for evaluation comprising: a memory which stores instructions; one or more processors coupled to the memory, wherein the one or more processors, when executing the instructions which are stored, are configured to: train a large language model (LLM), wherein the training includes a product information, wherein the product information resides within a product knowledge base, and wherein the product information relates to one or more products for sale; collect, by an embedded interface, input from one or more users, wherein the input from one or more users is related to the one or more products for sale, wherein the embedded interface includes a synthetic human, and wherein the input from one or more users includes a first input from a first user; create, by the LLM, a response to the first input from a first user, wherein the response is based on the product information within the product knowledge base, wherein the response is responsive to the first input from a first user; produce a video segment, wherein the video segment includes a performance by a synthetic human, wherein the performance is based on the response that was created; present, to the first user, within the embedded interface, the video segment that was produced; capture a second input, from the first user, wherein the second input is responsive to the presenting; evaluate, by the LLM, the response that was created, wherein the evaluating is based on the second input; and self-improve, by the LLM, the product knowledge base, wherein the self-improving is based on the evaluating, and wherein the self-improving relates to the product information.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video streaming comprising:
training a large language model (LLM), wherein the training includes product information, wherein the product information resides within a product knowledge base, and wherein the product information relates to one or more products for sale;
collecting, by an embedded interface, input from one or more users, wherein the input from one or more users is related to the one or more products for sale, wherein the embedded interface includes a synthetic human, and wherein the input from one or more users includes a first input from a first user;
creating, by the LLM, a response to the first input from a first user, wherein the response is based on the product information within the product knowledge base, wherein the response is responsive to the first input from a first user;
producing a video segment, wherein the video segment includes a performance by a synthetic human, wherein the performance is based on the response that was created;
presenting, to the first user, within the embedded interface, the video segment that was produced;
capturing a second input, from the first user, wherein the second input is responsive to the presenting;
evaluating, by the LLM, the response that was created, wherein the evaluating is based on the second input; and
self-improving, by the LLM, the product knowledge base, wherein the self-improving is based on the evaluating, and wherein the self-improving relates to the product information.

2. The method of claim 1 wherein the self-improving comprises determining a quality metric, wherein the determining is based on the second input.

3. The method of claim 2 further comprising revising the product information, wherein the revising is based on the quality metric.

4. The method of claim 3 wherein the quality metric includes a tone of the second input.

5. The method of claim 3 wherein the quality metric includes a lack of positive feedback in the second input.

6. The method of claim 1 wherein the self-improving comprises generating one or more self-learning instructions.

7. The method of claim 6 wherein the one or more of self-learning instructions includes inviting a seller of the one or more products for sale to update the product information within the product knowledge base, wherein the update is accomplished with a client management system (CMS).

8. The method of claim 1 wherein the self-improving comprises identifying a pattern of information gaps, wherein the identifying is based on one or more interactions with the one or more users.

9. The method of claim 8 wherein the collecting, the creating, the producing, the presenting, and the capturing comprise an interaction.

10. The method of claim 8 further comprising autonomously crawling, by the LLM, one or more third party websites, wherein the autonomous crawling is based on the pattern of information gaps, wherein the autonomous crawling obtains a data about the one or more products for sale.

11. The method of claim 10 further comprising adding, in the product information, the data that was obtained.

12. The method of claim 8 further comprising developing, by the LLM, a plurality of self-learning instructions, wherein the developing is based on the pattern of information gaps.

13. The method of claim 12 wherein the plurality of self-learning instructions includes requesting, of a seller of the one or more products within the product knowledge base, to update the product information, wherein the requesting is based on the first input, and wherein the update is accomplished with a client management system (CMS).

14. The method of claim 8 further comprising identifying, in the product knowledge base, needed product information, wherein the needed product information relates to the one or more products for sale, wherein the identifying is based on the pattern of information gaps.

15. The method of claim 14 further comprising asking a seller of the one or more products for sale within the product knowledge base, to change the product information, wherein the asking is based on the identifying, and wherein the change is accomplished with a client management system (CMS).

16. The method of claim 1 further comprising constructing, by the LLM, a second response to the second input, wherein the second response is based on the product information within the product knowledge base, wherein the response is responsive to the second input.

17. The method of claim 16 wherein the producing and the presenting include the second response.

18. The method of claim 1 wherein the training comprises recognizing incorrect information within the product knowledge base, and wherein the self-improving is based on the recognizing.

19. The method of claim 1 further comprising updating product information within the product knowledge base.

20. The method of claim 19 further comprising determining a structure to store the product information.

21. The method of claim 20 wherein the structure includes an embedding store.

22. The method of claim 21 wherein the creating comprises a multidimensional search on one or more vectors associated with the embedding store.

23. A computer program product embodied in a non-transitory computer readable medium for evaluation, the computer program product comprising code which causes one or more processors to perform operations of:
training a large language model (LLM), wherein the training includes product information, wherein the product information resides within a product knowledge base, and wherein the product information relates to one or more products for sale;
collecting, by an embedded interface, input from one or more users, wherein the input from one or more users is related to the one or more products for sale, wherein the embedded interface includes a synthetic human, and wherein the input from one or more users includes a first input from a first user;
creating, by the LLM, a response to the first input from a first user, wherein the response is based on the product information within the product knowledge base, wherein the response is responsive to the first input from a first user;
producing a video segment, wherein the video segment includes a performance by a synthetic human, wherein the performance is based on the response that was created;
presenting, to the first user, within the embedded interface, the video segment that was produced;
capturing a second input, from the first user, wherein the second input is responsive to the presenting;
evaluating, by the LLM, the response that was created, wherein the evaluating is based on the second input; and
self-improving, by the LLM, the product knowledge base, wherein the self-improving is based on the evaluating, and wherein the self-improving relates to the product information.

24. A computer system for evaluation comprising:
a memory which stores instructions;
one or more processors coupled to the memory wherein the one or more processors, when executing the instructions which are stored, are configured to:
train a large language model (LLM), wherein the training includes product information, wherein the product information resides within a product knowledge base, and wherein the product information relates to one or more products for sale;
collect, by an embedded interface, input from one or more users, wherein the input from one or more users is related to the one or more products for sale, wherein the embedded interface includes a synthetic human, and wherein the input from one or more users includes a first input from a first user;
create, by the LLM, a response to the first input from a first user, wherein the response is based on the product information within the product knowledge base, wherein the response is responsive to the first input from a first user;
produce a video segment, wherein the video segment includes a performance by a synthetic human, wherein the performance is based on the response that was created;
present, to the first user, within the embedded interface, the video segment that was produced;
capture a second input, from the first user, wherein the second input is responsive to the presenting;
evaluate, by the LLM, the response that was created, wherein the evaluating is based on the second input; and
self-improve, by the LLM, the product knowledge base, wherein the self-improving is based on the evaluating, and wherein the self-improving relates to the product information.
